(19) United States
(12) Patent Application Publication
(10) Pub. No.: US 2020/0250711 A1
(43) Pub. Date: Aug. 6, 2020

(54) METHOD AND SYSTEM FOR AUGMENTING VIDEO STREAM OF CARD-BASED FANSTASY GAME

(71) Applicant: CARDBOARD LIVE, INC., Charlottesville, VA (US)

(72) Inventors: James Chieh-Wei Hsu, Vancouver (CA); Matthew Quaine Thompkins, Los Angeles, CA (US)

(21) Appl. No.: 16/263,214

(22) Filed: Jan. 31, 2019

(51) Int. Cl. G06Q 30/02; G06Q 30/06; A63F 13/86; G06K 9/00

(52) U.S. Cl. CPC G06Q 30/0277; G06K 9/00718; A63F 13/86; G06Q 30/0625

(57) ABSTRACT

The present invention provides a method and system for large-scale data loading including generating a data science model with at least one million data points. The method and system includes determining at least one native data resource having native data stored thereon and determining a size of the model data generated from the native data by translating a model query format of the data science model into a native query format of the native data resource. The method and system queries the native data resources using the data science model and receiving the model data, including transporting the model data to temporary data resources. The method and system engages the model data with the data science model and trains the data science model using the model data stored in the temporary data resources. Where the iterative training process requires multiple data-loading operations made possible under the present method and system.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent files or records, but otherwise reserves all copyright rights whatsoever.

### FIELD OF INVENTION

The present invention relates generally to video feed processing techniques and more specifically to detecting elements within a video feed and augmenting the video feed based thereon.

### BACKGROUND

Technology advancements have significantly improved gaming experiences, including individual and online gaming. There is also a significant growth in gaming viewership, such as livestreaming gameplay, video gameplay clip distribution, electronic sports leagues, etc.

As card-based fantasy games grow in popularity, video game technology improvements are not readily applicable because of the in-person and physical nature of these games. Card-based fantasy games include well-known games using a wide variety of game cards from a collection of cards. Players collect various cards within their deck, available for gameplay against other players. A common example includes Magic the Gathering available from Wizards of the Coast, LLC.

Where there are videogame versions of card-based games, technology has not advanced to account for in-person card-based games and viewership associated therewith. For example, while players can play electronic versions of these fantasy-based card games, current technology lags behind relating to the physical in-person card play.

One growth area is live gameplay video distribution. For example, if a number of players are sitting in the same room, physically playing a fantasy-based card game, one or more cameras can be recording and distributing a video feed of this gameplay. Under current technology, viewership is passive, simply watching the gameplay without interaction.

Existing video processing technology provides for content recognition and potential content overlay technology. For example, U.S. Pat. No. 6,100,925 teaches the first-down marker visible in televised football games. Object detection technology includes various improvements, such as noted in U.S. Publication No. 2013/0070096 analyzing elements within an image to detecting distance and sizing between elements. There is also well known techniques for providing information, e.g. advertisements, based on recognition activities for a communication session, as noted in U.S. Publication No. 2013/0057691.

But these improvements have not been applied to video distribution of fantasy-based card games. For example, these card decks can include many thousands of playing cards, each having the same size with minor design differences. The number of available cards and design variances complicates supplementing or augmenting gameplay with card-specific information. Add in the live nature of video streaming, current technology does not provide for allowing image recognition to be performed within the streaming environment.

Therefore, with the growth of popularity and the gameplay video distribution, there is a need for further improving the user experience associated with card-based games, including automatically and electronically augmenting the video display with card-specific information.

### BRIEF DESCRIPTION

The present invention provides a computerized method and system for augmenting a video stream of players playing a card-based fantasy game. The card-based fantasy game includes multiple players physically playing different game cards in turns or sequence of turns as game strategy in competition with each other. Recording and distributing this in-person gameplay provides the video stream.

The method and system includes detecting, from the video stream, an outline of a card being played within the card-based game. As a player lays down a particular card on the playing board or game table, the method and system analyzes the video feed for detecting the outline of the card, such as a rectangular outline.

An image of the card is within the outline of the card. But the outline can be any shape, as although the card itself may be rectangular, the outline and image of the card on the video feed is not necessary a clear, straight-on, image due to variances in camera angles and movements of the card during gameplay. Therefore, the method and system includes processing the image of the card within the outline to recognize the card without interrupting the video stream.

Upon recognizing the card, the method and system accesses a reference database to determine card data associated with the card. By way of example, card data may be information about the card itself, such as card type, powers, etc. In another example, card data can be commercial data, such as a link to a commercial site hosting a sale or auction of the specific card.

The method and system therein formats the card data for distribution to at least one viewer. The formatting of the card data can be dependent on the type of data, such as text formatting or in the example of commercial information, formatting can include hyperlink formatting or redirection instructions.

Thereby, the method and system distributes the card data to a viewer application for complimenting the video stream. In one embodiment, a user may view the video stream and the card data in a common viewer, such as a viewing application from a content distribution engine. In another embodiment, the user may view the video stream in a viewing window or application and the card data in a second screen or complimentary application. Whereby, the method and system provides for concurrent distribution of the video stream and the card data, augmenting the video stream without interruption to acquire the card data.

In one embodiment, the method and system may receive the video stream from an external streaming source. For example, streaming video of gameplay can be distributed across a video platform, the method and system using that external video feed. Whereby, the method and system can operate on top of existing video distribution systems, augmenting the video stream without placing recording or processing requirements on the entity recording the original video content.

In one embodiment, the image recognition can be performed using a hashing algorithm. In one embodiment, due to complexities of the image recognition technique and for insuring higher accuracy, one technique may include cryptographic hashing. Herein, the reference database can include corresponding cryptographic hash values for specific cards.

For further improving the accuracy and timeliness of card recognition, one embodiment of the method and system includes pre-populating the reference database with the cards of the players' decks prior to starting gameplay. For example, if two player each begin a game with twenty cards in their decks, the reference database can be pre-populated with those forty cards. Thus, card detection can be referenced relative to a pre-determined set of possible cards instead of a much broader universe of cards available for gameplay.

In another embodiment, the method and system can also monitor the sequence of gameplay. In one embodiment, this can provide additional information within the card data or in another embodiment allow for predictive techniques for improving card recognition. For example, in one embodiment it may be predicted that a particular card or type of card follows another card. Predictability can narrow the scope of cards for image recognition, as well as improving card data, e.g. predicting a gameplay or rating a strength of gameplay.

Whereby, the method and system described herein improves video distribution of a card game video stream by detection and recognition, as well as supplemental content distribution without disrupting the video stream itself.

### BRIEF DESCRIPTION OF THE DRAWINGS

FIG. 1 illustrates a block diagram of a processing system for augmenting a video stream;

FIG. 2 illustrates a block diagram of one embodiment of the processing device providing for augmenting a video stream;

FIG. 3 illustrates a sample screenshot from a video stream having fantasy-based card game gameplay;

FIG. 4 illustrates one embodiment of edge detection on the video stream of FIG. 3;

FIG. 5 illustrates a flowchart of the steps of one embodiment of a method for augmenting a video stream;

FIG. 6 illustrates a flowchart of the steps of one embodiment of an algorithm for augmenting a video stream;

FIG. 7 illustrates a multi-user subscription service including processing for augmenting video streams; and

FIGS. 8 and 9 illustrate a sample screenshots of a viewer.

A better understanding of the disclosed technology will be obtained from the following detailed description of the preferred embodiments taken in conjunction with the drawings and the attached claims.

### DETAILED DESCRIPTION

FIG. 1 illustrates a block diagram of a system 100 for augmenting a video stream. The system 100 is accessible by a user 102 having a computing device 104 with a user interface (UI) 106 thereon. The system includes a processing device 108 accessing an image database 110 and a card information database 112, as well as receiving input from a video stream distributor 114.

The user 102 may be any suitable user viewing or otherwise interacting with the UI 106 on the computing device 104. The computing device 104 may be any suitable processing device operative to execute the UI 106, engaging connectivity to the processing device 108 or any other intermediate server or system not expressly shown. By way of example, the computing device 104 can be a desktop or mobile computer, a set-top box, or a gaming console. In another example, the computing device 104 can be handheld device, such as a mobile or smart phone, a tablet computer, etc. The computing device 104 may be any suitable device or combination of devices allowing for the user 102 to receive content via the user interface 106 as described herein.

Communication between the processing device 108 and the device 104 can be across any suitable communication medium, such as wireless network, wi-fi connection, wired network connection, cable connection, etc.

The UI 106 may be any suitable application allowing for viewing a video stream. In one embodiment, the UI 106 can be a stand-alone dedicated viewer application receiving a wide variety of streaming content, for example the Twitch® UI 106, available from Amazon, Inc. The UI 106 may be a proprietary or dedicated viewer for subscriber content. The UI 106 may include additional functionality beyond static content viewing, allowing for interactivity, for example selecting hyperlinks or accessing externally-referenced content.

The processing device 108 may be one or more processing devices for performing processing operations as described herein. The processing device 108 can be a combination of processing devices centrally located or in a distributed environment. The processing devices 108 may be distributed across a wide area network, such as the Internet in a distributed or cloud-based computing environment, whereby the proximity of the processing device 108 to the video stream content generation is not expressly limited. Rather, as described in greater detail below, the processing device 108 performs processing operations on a received video stream and can receive the stream across a networked or any other suitable distribution network.

The databases 110 and 112 can be any suitable data storage location or locations having data stored therein. For example, the databases 110 and 112 can be unitary data storage units, or can be distributed storage across a plurality of networks, centrally located or distributed. The image database 110 includes image fingerprint data relating to values representing images of playing cards.

As used herein, game play cards can refer generally to physical cards, such as 4″ by 6″ playing cards. Whereas, the term cards can more generally refer to any playable gaming elements within a fantasy-based card game, such as a coin, an odd-shaped card, a token, a multi-sided die or dice, or any other suitable gaming element or artifact.

The card information database 112 stores any additional information relating to gameplay cards. By way of example, but not expressly limiting, card data can include commercial information of a marketplace where the card is for sale, card data can include background story about the card, card data can include play data about the card, e.g. frequency of card, uniqueness of play, etc. In another embodiment the totality of gameplay can be a factor for card data, such as expressing the value of a play or move relative to the prior cards having been played, or for example with knowledge of the players' decks.

The video stream distributor 114 is any suitable device or system generating a video stream. For example, in one embodiment this device 114 may be a broadcaster directly broadcasting live in-person gameplay. In another example, the device 114 may be a livestream distribution server allowing for users to access the server and livestream or otherwise view gameplay.

The computerized system 100 includes the processing device 108 performing processing operations in response to executable instructions stored in a computer readable medium (not expressly illustrated). The processing device 108 receives the video stream from the distributor 114. As described in greater detail below, the processing device 108 performs processing operations to detect a card within the video stream, including initially detecting an outline of the card and then performing image recognition operations.

The processing device 108 accesses the image database 110 for retrieving the identification of the card and therein uses this identification to retrieve card information from the database 112.

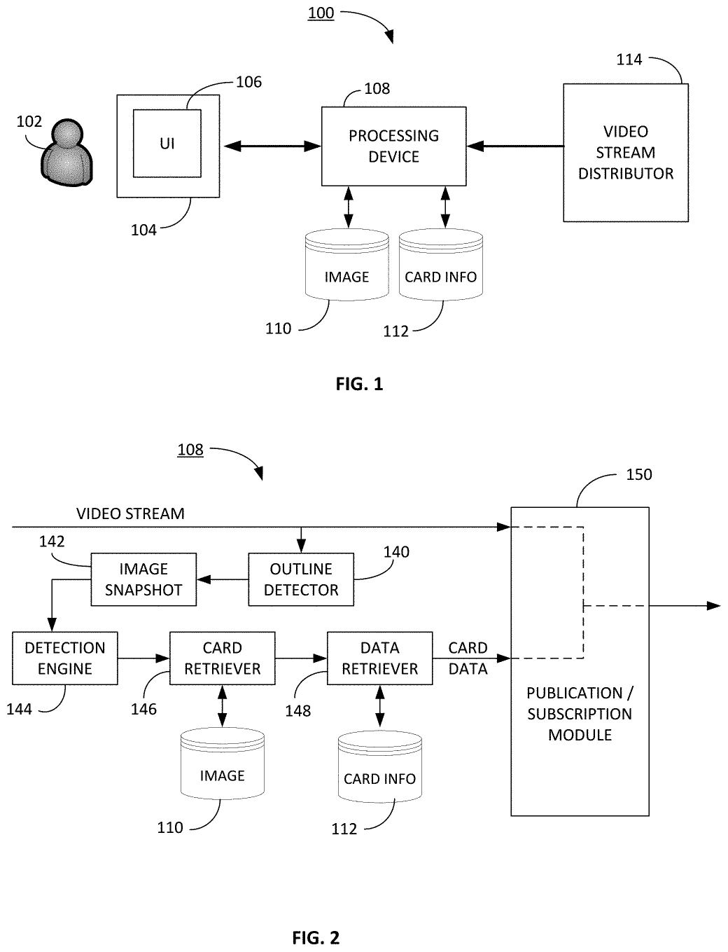

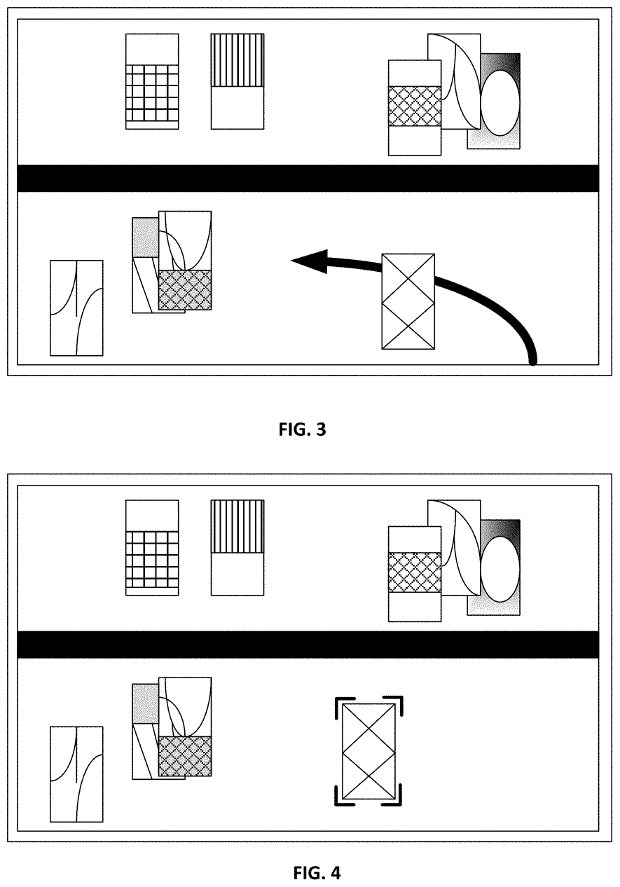

The processing device 108 distributes the card information to the user 102 viewable on the UI 106. The system 100 augments the video stream of players playing a card-based fantasy game without disrupting the video stream distribution.

Where FIG. 1 is a general system overview, FIG. 2 illustrates the processing device 108 in greater detail. It is recognized that to one skilled in the art, numerous processing elements are omitted for clarity purposes only, such as for example data input reception devices, security and other user registration modules, etc.

As illustrated in FIG. 2, the processing device 108 includes a plurality of processing modules, including an outline detector module 140, an image snapshot engine 142, a detection engine 144, a card retriever 146, a data retriever 148, and a publication/subscription module 150. These modules may be stand-alone processing modules or may be disposed within more general processing routines for performing processing operations as described herein.

The processing device 108 receives the video stream, such as from the distribution device 114 of FIG. 1. As the video stream proceeds in a sequence of continuous images, the outline detector 142 analyzes the video stream to detect a card outline.

By way of example, FIG. 3 illustrates a sample screenshot of one segment of a card game with multiple cards, here the card with four Xs is being played. For clarity purposes, the hand of the player laying the card on the table is not illustrated). The play of the card is represented by the arcing arrow representing the movement of the card, the arrow not visible within the livestream.

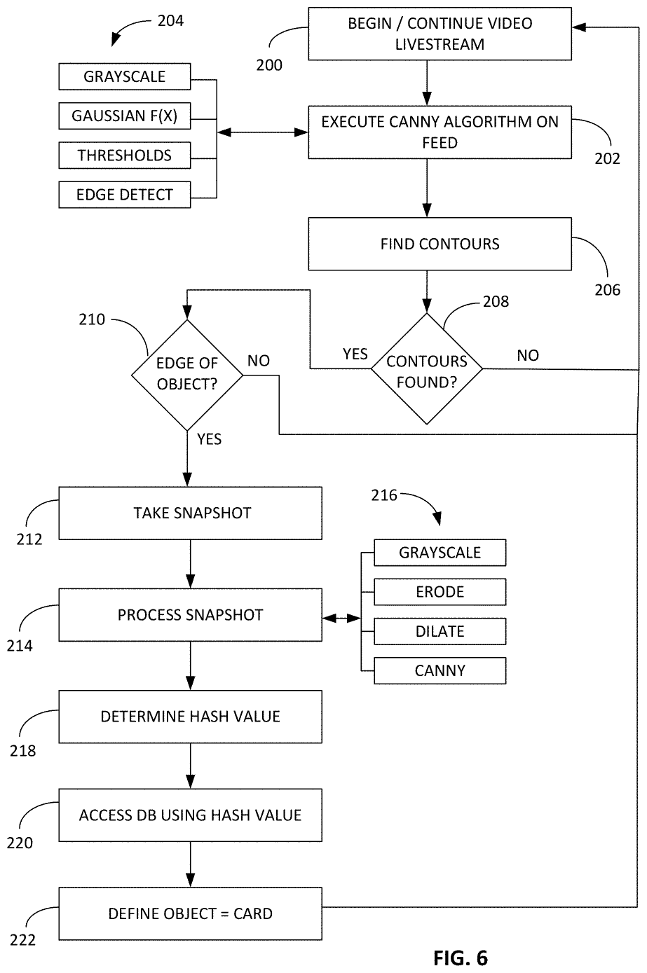

Using the outline detector, FIG. 4 illustrates a visual representation detecting edges of the card. Here, the card is detected by having 4 distinct corners. Further discussion of the operations of the outline detector is noted with respect to FIG. 6 below.

Upon outline detection, the image snapshot module 142 creates a snapshot from the video feed. The snapshot is a single frame of the video feed allowing for additional image processing thereon.

Using the snapshot, the detection engine 144 performs image recognition operations on the card. For example, one embodiment may include using a hashing algorithm to convert the visual image into an image fingerprint, such as using any suitable well-known image to perceptual hashing technique.

Herein, the video stream displays fantasy-based card game gameplay, where these cards have ornate designs, sometimes with minimal variations between different cards. For example, all cards for a particular set may have the same general aesthetics, with common background designs, with variations as to card types, e.g. offensive, defensive, etc., and differences with names, words, and images. The commonalities of these cards complicates performing image recognition on a video frame snapshot. Thus, one embodiment includes the hashing algorithm using a cryptographic hashing technique allowing for higher accuracy in generating the image fingerprint.

Having this image fingerprint, the card retriever 146 access the database 110 to retrieve the name of the card. For example, the image fingerprint can identify the card as “Anaba Shaman” from Magic The Gathering®. Having this card name, the data retriever 148 then accesses database 112 to retrieve card information. The card information can be any suitable information relating to the card. Using the example of “Anaba Shaman,” the card data can include background or related information on the card. In another example, the card data may include a link to a commercial marketplace where the card is being offered for sale. In another example, the card data can relate to the gameplay relative to the totality of gameplay based on tracking current gameplay activities, including when the card is played within the game or into which zone or segment of the board the gameplay occurs.

The pub/sub module 150 receives the card data from the retriever 148, as well as the video stream. The module 150 then distributes the card data to a viewing device (not shown) concurrent with the video stream. In one embodiment, the processing device 108 does not buffer or otherwise slow down the video stream to perform the image recognition. Therefore, any delay between the activity within the video stream and augmentation with the card data is due to processing time for performing the operations of modules 140-148.

Various embodiments allow for improving the accuracy and timing of the module 140-148 operations. For example, in gameplay, each player begins the game with a defined deck of cards. Therefore, the image database 110 can be pre-populated with just images for cards within the decks. For example, a complete deck may include upwards of 20,000+ cards, all with different images. Thus, if two players each have 20 cards, the database search is not reduced to search relative to 40 entries instead of 20,000.

In another embodiment, the system may include machine learning to improve image recognition techniques. Using a preset knowledge set, e.g. each player's decks, the system may apply machine learning iterative knowledge for improve image recognition operations. For example, one embodiment with machine learning may include applying known machine learning techniques to improve recognition accuracy, including using user feedback or automated feedback. User feed may include manual oversight of card recognition. By contrast, automated feedback may include utilizing pre-existing knowledge of player decks, such as performing a recognition operation and then comparing those results to the known decks for the player, such that recognizing the card being within the deck indicates a correct recognition. Machine learning operations, consistent with known machine learning techniques, can improve card recognition through iterative training operations.

Having preexisting card information can also assist in minimize time for collecting card data. For example, using the above example of knowing of 40 potential cards for a game, the card information database 112 can pre-populate with commercial marketplace information, e.g. links to online sales or auctions, for these cards instead of conducting any searching for this information while the card is being played in the video feed.

In another example, the card information may include source identifying information relative to the image recognition techniques herein. For example, if the card data is a hyperlink to a commercial website for purchasing the card, pub/sub module 150 or the card information in the database 112 can include referral identifier information indicating the sales lead was originated due to the image recognition operations. One example would be adding reference terms to the tail of a URL or utilizing an intermediate URL such as a truncated URL technique.

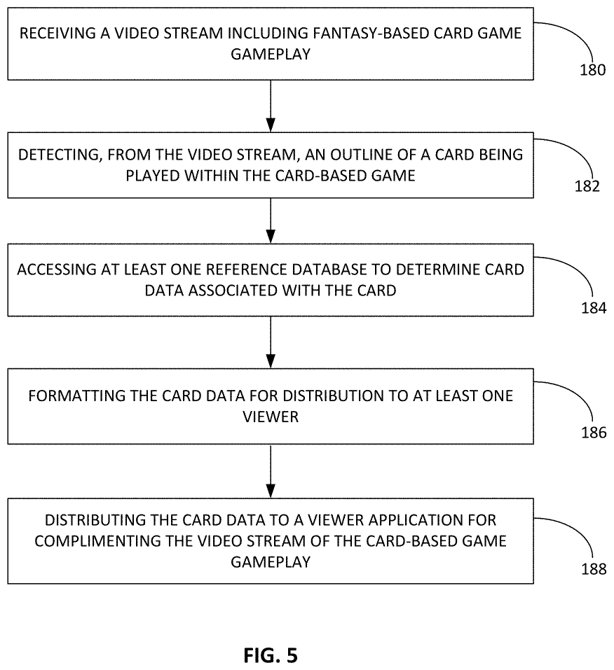

FIG. 5 illustrates a flowchart of the steps of one embodiment of a computerized method for augmenting a video stream. The steps may be performed, in one embodiment, using the processor 108 of FIG. 2. A first step, step 180, is receiving a video stream including fantasy-based card game gameplay. This video stream can be from any suitable source, including live recording of current gameplay, livestreaming of previously gameplay, etc.

Step 182 is detecting, from the video stream, an outline of a card being played, such as performed using, from FIG. 2, outline detector 140, snapshot engine 142, and detection engine 144, and card retriever 146 with an image fingerprint. Step 184 is accessing at least one reference database to determine card data associated with the card, such as using the retriever 184 and the card information database 112 of FIG. 2.

Step 186 is formatting the card data for distribution to at least one viewer, such as may be performed by the pub/sub module 150 of FIG. 2. Whereby, step 188 is distributing the card data to a viewer application for complimenting the video stream of the card-based game gameplay.

In one embodiment, the video stream is received from an external video stream source. For example, the source may be a livestream site or may be a broadcaster. In one embodiment, the video stream may be internal to the image recognition, such as being executed within the same content generation and distribution system.

In one embodiment, the distribution of card data may be to a single viewer or viewing source, such as single UI having a first window for the livestream and a second window the card data. In another embodiment, the distribution of the livestream may be a first viewer and the card data may be to a second viewer, such as being commonly executed, e.g. on the same computer, as the first viewer, or a completely different device, e.g. a second screen.

FIG. 6 illustrates a flowchart of a further embodiment of the card detection operations. The flowchart illustrates the iterative nature of the processing technique for active gameplay that includes continuous sequential gameplay.

Step 200 is to begin or continue the video streaming. As the livestream is fed through a viewing application, video processing techniques seek to improve detecting the card. Live video streaming includes any number of card detection and recognition complications.

One complication is that different camera angles for live video cause cards to be viewed at odd angles. Where FIG. 3 screenshot shows an overhead view and the rectangular nature of the card is readily identifiable, the processing operations account for side views. In a side view, the rectangular shape of the card is now trapezoidal.

Another complication is the complexity of the images on the cards. As noted above, a deck may have upwards of 20,000 cards with common aesthetics. With any degradation in video quality, many of these cards may look similar, if not identical. Image capturing angles, such as the card being trapezoidal in shape, only further compounds image recognition difficulties.

Another complication is the continuous nature of image recognition and the continuous video feed. By not including a delay in the video feed, the image recognition occurs within a real time of the card play.

Therefore, the present method and system includes utilizing one or more image processing techniques. Step 202 is executing a canny algorithm on the video feed. The Canny algorithm is a known video processing technique for improving edge detection within an image, including processing modules 204, such as grayscale, gaussian functions, upper and lower threshold definitions, and object edge detection operations.

Step 206 is finding contours within the video feed. The contours are image processing markers indicating edges of an elements within the feed. The contours 206 are general to cards or relative to card game specifics. Therefore, inquiry step 208 is whether the contours are found. Finding contours is based on image processing techniques continually scanning the images of the video feed.

If the contours are not found in step 208, the method reverts back to step 200 to continue monitoring the video stream. If the contours are found, the method proceeds to step 210 for determining if the contour may be the edge of the object. For example, a typical game card is 4 inches by 6 inches, thereby based on a scale factor, the processing operations can include determining if the element is likely to be sized 4 inches by 6 inches. In further processing techniques, the processing engine may account for off-center or side camera angles, thus further sizing operations can account for offset camera angles, for example the card being trapezoidal shaped. Similarly, for non-card based images, the determination of edges can be predicated on the predicted shape of the object, such as a coin have a circular or oblong shape, a multi-sided die having an orthogonal shape, etc.

Step 210 is an inquiry step. If the contours do not determine or estimate an edge of the object, the method reverts back to step 200. In the above embodiment of processing the video feed, the contour and dimensions of the edges determined using the Canny algorithm. If the edge is found, step 212 is a acquiring a snapshot of the video feed. For example, this snapshot may be extracting a single frame from the video feed, allowing for further processing to be performed on this snapshot.

Step 214 is processing the snapshot for image recognition. Varying image processing modules 216 can be utilized to improve the accuracy and reliability of the image recognition operations. For example, grayscaling operations can eliminate complications due to coloring variances. In another example, erode operations can soften edges and dilate operations can expand the image. Similarly, one embodiment may include Canny image processing techniques.

In processing the snapshot, step 218 is determining the hash value, e.g. the image fingerprint. One embodiment includes using cryptographic hashing algorithms for improved accuracy. Step 220 is accessing a database using the hash value and step 222 is defining the object as the specific card identified from the database access. Therein, the method of FIG. 6 reverts to step 200 for continue processing, as after this card play, another player will be playing another card and the method seeks to recognize that next card.

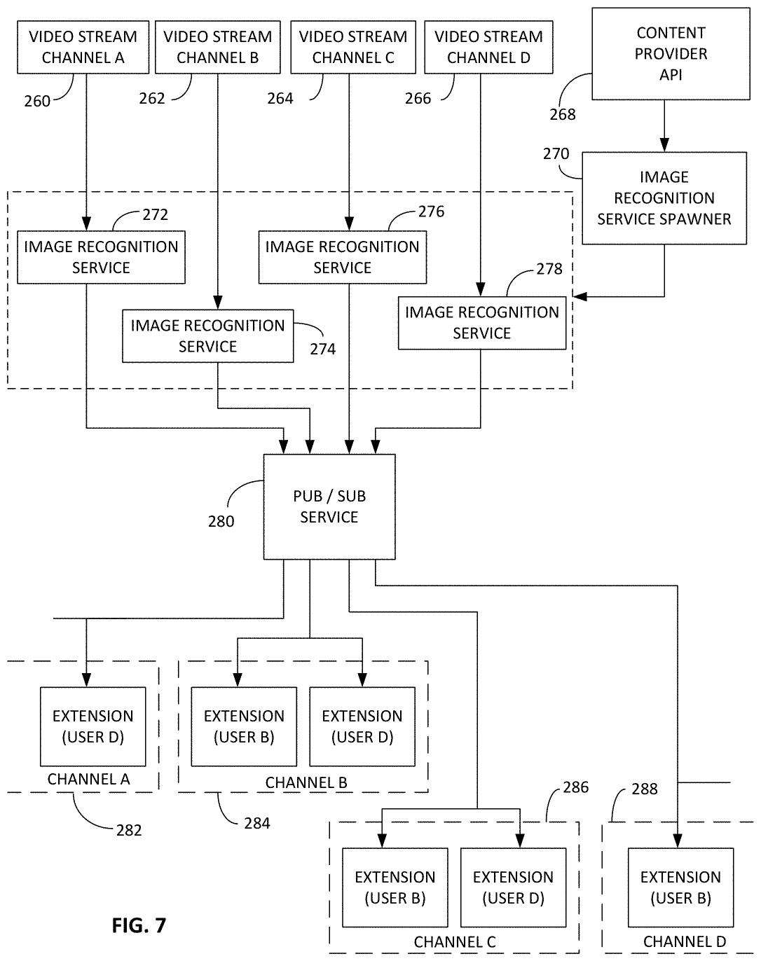

The above system and method is described relative to a single video feed with a single viewer, but the method and system equally applies to any number of feeds and any number of viewers. FIG. 7 illustrates one embodiment for augmenting video streams. The system includes a plurality of video stream channels, channel A 260, channel B 262, channel C 264, and channel D 266. These streams can be unique streams originating from different sources. Or in another example, e.g. if a large tournament is occurring, the feeds may be individual matches within the tournament.

The video streams are viewable using any suitable type of browser or viewing application. A common example of current video stream viewing is via a Twitch® browser or any other commercially-available browser or application. The content provider, the source of the video channels, includes an API 268 indicating the various streams.

In the present method and system, an image recognition service (IRS) spawner module 270 becomes aware of the active channels 260-268. In one embodiment, an IRS is spawned for each channel. Therefore, in this example IRS 272 is spawned for channel A 260, IRS 274 for channel B 262, IRS 276 for channel C 264, and IRS 278 for channel D 266. Each IRS may perform operations as noted within processor 108 of FIG. 2.

For each channel, 260-266, each IRS then processes the stream to detect cards being played. Not expressly illustrated, each IRS may access a common data repository, e.g. databases 110 and 112 of FIG. 2, may have their own database(s), or a combination of dedicated and shared memory.

The pub/sub service module 280, in this embodiment, acts as a gateway for content distribution. Where there are multiple channels, there are multiple subscribers viewing one or more channels. Therefore, the pub/sub service module 280 distributes channel A content 282, channel B content 284, channel C content 286, and channel D content 288.

Channel subscription and access may be performed using known techniques for taking multiple incoming feeds and distributing these feeds to different users based on subscription or access request. The pub/sub service module 280 improves content distribution by augmenting the distribution of the video stream to additional include the card data acquired from each of the IRS 272-278.

In one embodiment, the pub/sub service module operates as the heart and soul of the system by including card data. As the IRS determines the card being played, the pub/sub service module 280 accesses card data for augmenting the video feed. This may include informational data, commercial data, gameplay data, etc.

In one embodiment, the module 280 may include additional processing techniques for card data. For example, one embodiment may include keeping a list of cards being played relative to a pre-existing deck list (e.g. counting cards) and providing a play estimate for forthcoming play options by different players. In another example, by tracking previous gameplays, one technique may include determining a significance value for a card play. For example, a significant value can include a likelihood of winning based on the particular play, or the strength of a player's hand, etc.

The module 280, with additional processing parameters, can thereby augment the gameplay by including dynamic gameplay-related information. Otherwise, the card data can be static data, such more information about the card, where the card is available for purchase, etc.

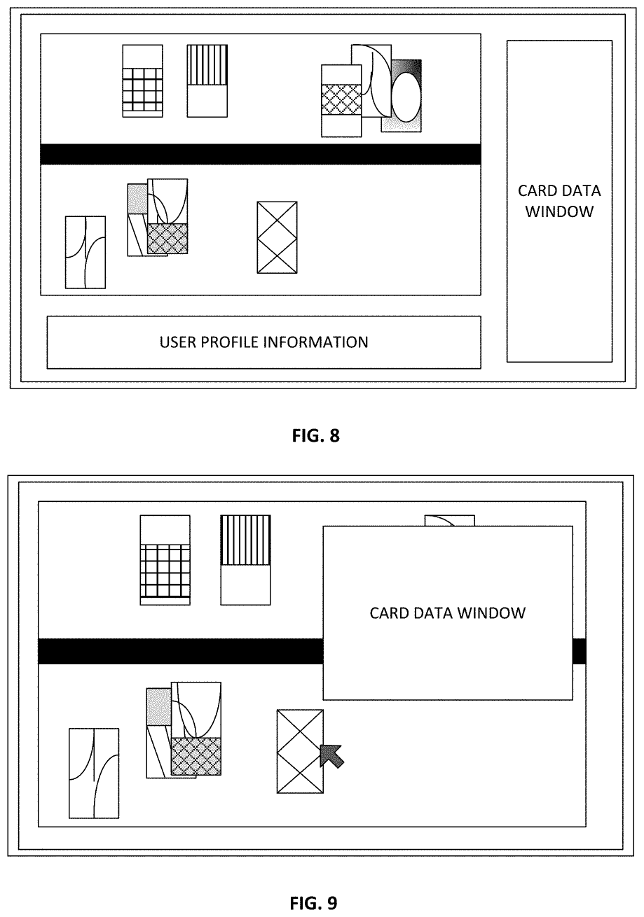

FIG. 8 illustrates one example of a viewer showing gameplay and card data. In this example, the viewer includes gameplay in a main window with card data window to the side. In this example, a bottom window may include user profile information. Here, the card data window can include interactivity, such as if the card data includes an active hyperlink, a user can select the link and view additional information or be directed to another site.

FIG. 9 illustrates another example of a viewer with gameplay and card data. In this example, card data may be visible in a screen overlay. For example, the overlay screen may be activated by holding a cursor over the newly played card.

Similarly, the card data is not expressly limited to an actively played card. For example, the card data can be a scroll screen having the previous card data readily accessible. In the example of overlay, an overlay screen activation, e.g. mouse-over for example, can apply to all cards having card data. In this example, a viewer can see all the currently-played cards and access card data for any card in an overlay.

In one embodiment, where the image processing is a continuous scan, image recognition can include recognizing all cards or gaming elements on a board and providing not just new card information, but also the previously-provided card information. In the example of a cursor overlay, placing a cursor or mouse over any card or game piece can then enable a pop-up window or other display formatting showing corresponding card data.

In addition to the recognition of a card or playing element, one embodiment further includes noting the sequence, timing, or location of gameplay. For example, a card played in an early move or a first game board zone may have a different meaning or value from being played later in the game or in a different zone. Therefore, one embodiment includes not only recognizing the cards being played, but also the sequence of gameplays, which can be included as part of card information. For example in this embodiment of a data field noting the sequence of gameplay can represent or provide for prior gameplay events, e.g. player two played “card X” in response to player one playing “card y.”

Additionally, the above embodiments provide for image recognition with disruption of the video feed. Further embodiments may include video feed disruption in a non-live or a non-time sensitive environment. For example, if a tournament occurs in Asia and the video broadcast is to be viewed in Europe or the US, the video feed can be delayed. Therefore, additional embodiments may account for pausing or delaying the video feed for image recognition techniques described herein, such as for example pausing the video feed when a snapshot is taken and resuming the feed once the snapshot is processed. In another example, the interruption of the video feed can include feedback or machine learning iterations for improving recognition accuracy. Whereby, the present method and system is not expressly limited to operating in a real-time environment but can also perform content recognition for augmenting a video stream in a post-processing or a delayed environment.

Thereby, the present method and system improves video feeds of in-person fantasy-based card game gameplay. Augmenting the viewing experience includes detecting cards being played and providing supplemental information to the user. These techniques are performed in a real-time environment without distribution or delaying video distribution.

FIGS. 1 through 9 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

1. A computerized method for augmenting a video stream of players playing a card-based fantasy game, the method comprising:
detecting, from the video stream, an outline of a card being played within the card-based fantasy game the card having an ornate design representing an element of gameplay of the card-based fantasy game;
processing an image within the outline to recognize an image fingerprint of the card based on the ornate design of the card without interrupting the video stream;
accessing at least one reference database to determine card data associated with the card, the card data being play data about the card including a value of the card being played in context of the card-based fantasy game;
formatting the card data for distribution to at least one viewer; and
distributing the card data to a viewer application for complimenting the video stream of players playing the card-based fantasy game, wherein the card data includes commercial information including a computerized link for accessing a marketplace for purchasing the card.

2. The computerized method of claim 1 further comprising:
receiving the video stream from an external video stream source.

3. The computerized method of claim 1, wherein processing the image includes generating a cryptographic hashing, the method further comprising:
accessing the at least one reference database using the cryptographic hashing.

4. The computerized method of claim 1 further comprising:
for each of the players playing the card-based fantasy game, receiving player deck information including data indicating each of the cards held by the player within the player deck to pre-populate an image database with images of the cards in the player decks prior to a start of playing the card-based fantasy game; and
utilizing the player deck information and the images of the cards for recognizing the card without interrupting the video stream.

5. The computerized method of claim 1, wherein the viewer application includes displaying the video stream of card-based gameplay and the card data concurrently.

6. The computerized method of claim 1, wherein the viewer application is a stand-alone viewer application independent from the video stream.

7. (canceled)

8. The computerized method of claim 1 further comprising:
after determining the card, referencing a gameplay sequence list;
determining a significance value for the card relative to the gameplay sequence list; and
updating the card data based on the significance value.

9. A computerized method for augmenting a plurality of video streams, the method comprising:
receiving the plurality of video streams, each of the video streams including video of players playing card-based fantasy games;
for each of the video streams, instantiating a card detection module, the card detection module:
detecting, from the video stream, an outline of a card being played within the card-based fantasy game the card having an ornate design representing an element of gameplay of the card-based fantasy game;
processing an image within the outline to recognize an image fingerprint of the card based on the ornate design of the card without interrupting the video stream;
accessing at least one reference database to determine card data associated with the card, the card data being play data about the card including a value of the card being played in context of the card-based fantasy game; and
adding the card data to the video stream; and
distributing the plurality of video streams and card data associated therewith to a plurality of viewers, wherein the card data includes commercial information including a computerized link for accessing a marketplace for purchasing the card.

10. The computerized method of claim 9, wherein processing the image includes generating a cryptographic hashing, the method further comprising:
accessing the at least one reference database using the cryptographic hashing.

11. The computerized method of claim 9 further comprising:
for each of the players playing the card-based fantasy game, receiving player deck information including data indicating each of the cards held by the player within the player deck to pre-populate an image database with images of the cards in the player decks prior to a start of playing the card-based fantasy game; and
utilizing the player deck information and the images of the cards for recognizing the card without interrupting the video stream.

12. The computerized method of claim 9, wherein the viewer application includes displaying the video stream of card-based gameplay and the card data concurrently.

13. The computerized method of claim 9, wherein the viewer application is a stand-alone viewer application independent from the video stream.

14. (canceled)

15. A system for augmenting a video stream of players playing a card-based fantasy game, the system comprising:
computer-readable medium having executable instructions stored therein; and
at least one processing device, in response to the executable instructions, operative to:
detect, from the video stream, an outline of a card being played within the card-based fantasy game the card having an ornate design representing an element of gameplay of the card-based fantasy game;
process an image within the outline to recognize an image fingerprint of the card based on the ornate design of the card without interrupting the video stream;
access at least one reference database to determine card data associated with the card, the card data being play data about the card including a value of the card being played in context of the card-based fantasy game;
format the card data for distribution to at least one viewer; and
distribute the card data to a viewer application for complimenting the video stream of card-based game gameplay, wherein the card data includes commercial information including a computerized link for accessing a marketplace for purchasing the card.

16. The system of claim 15, wherein the processing device is further operative to:
receive the video stream from an external video stream source.

17. The system of claim 15 wherein processing the image includes generating a cryptographic hashing, the processing device further operative to:
access the at least one reference database using the cryptographic hashing.

18. The system of claim 15, the processing device further operative to:
for each of the players playing the card-based fantasy game, receive player deck information including data indicating each of the cards held by the player within the player deck to pre-populate an image database with images of the cards in the player decks prior to a start of playing the card-based fantasy game; and
utilize the player deck information and the images of the cards for recognizing the card without interrupting the video stream.

19. (canceled)

20. The system of claim 15, the processing device further operative to:
after determining the card, reference a gameplay sequence list;
determine a significance value for the card relative to the gameplay sequence list; and
update the card data based on the significance value.

21. The computerized method of claim 1 further comprising:
distributing referral identifier information within the computerized link for accessing the marketplace, the referral identifier information indicating an origination of a sales lead.

22. The computerized method of claim 9 further comprising:
distributing referral identifier information within the computerized link for accessing the marketplace, the referral identifier information indicating an origination of a sales lead.

23. The system of claim 15, the processing device further operative to:
distribute referral identifier information within the computerized link for accessing the marketplace, the referral identifier information indicating an origination of a sales lead.
